(19) United States
(12) Patent Application Publication
(10) Pub. No.: US 2011/0128199 A1
(43) Pub. Date: Jun. 2, 2011

(54) FIELD-CONFINED WIDEBAND ANTENNA FOR RADIO FREQUENCY FRONT END INTEGRATED CIRCUITS

(76) Inventors: Ziming He, Irvine, CA (US); Ping Peng, Irvine, CA (US); Oleksandr Gorbachov, Irvine, CA (US)

(21) Appl. No.: 12/914,922

(22) Filed: Oct. 28, 2010

Related U.S. Application Data
(60) Provisional application No. 61/256,172, filed on Oct. 29, 2009.

(51) Int. Cl. H01Q 13/10; H01Q 7/00; H01Q 1/42

(52) U.S. Cl. 343/742; 343/741

(57) ABSTRACT

A field-confined wideband antenna assembly is disclosed. The antenna assembly includes a radiating element with a planar body that defines a first confining slot. The dimensions of the first confining slot correspond to a first set of resonance frequencies of the radiating element. A feeding line extends from the radiating element in an angularly offset relationship to the planar body. A first grounding line extends from the radiating element in an angularly offset relationship to the first body. A dielectric assembly supports the planar body of the radiating element. There is a first high frequency current loop that is formed from the feeding line to the radiating element about the first confining slot and to the first grounding line. With this, the first high frequency current loop confines current and electric fields on the radiating element.

### CROSS-REFERENCE TO RELATED APPLICATIONS

This application relates to and claims the benefit of U.S. Provisional Application No. 61/256,172 filed Oct. 29, 2009 and entitled “FIELD-CONFINED WIDEBAND ANTENNA TECHNOLOGY FOR RF FRONT-END IC APPLICATIONS”, which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radio frequency (RF) communications and antennas, and more particularly to a field-confined wideband antenna for use with RF integrated circuits.

2. Related Art

Wireless communications systems find application in numerous contexts involving information transfer over long and short distances alike, and there exists a wide range of modalities suited to meet the particular needs of each. These systems include cellular telephones and two-way radios for distant voice communications, as well as shorter-range data networks for computer systems, among many others. Generally, wireless communications involve a radio frequency (RF) carrier signal that is variously modulated to represent data, and the modulation, transmission, receipt, and demodulation of the signal conform to a set of standards for coordination of the same.

One fundamental component of any wireless communications system is the transceiver, i.e., the transmitter circuitry and the receiver circuitry. The transceiver encodes information (whether it be digital or analog) to a baseband signal and modules the baseband signal with an RF carrier signal. Upon receipt, the transceiver down-converts the RF signal, demodulates the baseband signal, and decodes the information represented by the baseband signal. The transceiver itself typically does not generate sufficient power or have sufficient sensitivity for reliable communications. The wireless communication system therefore includes a front end module (FEM) with a power amplifier for boosting the transmitted signal, and a low noise amplifier for increasing reception sensitivity.

Another fundamental component of a wireless communications system is the antenna, which is a device that allow for the transfer of the generated RF signal from the transceiver/front end module to electromagnetic waves that propagate through space. The receiving antenna, in turn, performs the reciprocal process of turning the electromagnetic waves into an electrical signal or voltage at its terminals that is to be processed by the transceiver/front end module.

In earlier mobile communication devices such as cellular phones, a conventional antenna was typically mounted on the case of the phone. These antennas were physically large and of various structures, including balanced fed dipoles, monopoles, and loops. Recent marketplace demand, however, has driven the miniaturization of mobile communication devices, concurrently with the incorporation of ever-increasing levels of functionality. Indeed, current smart phones have e-mail features, web browsing features, global positioning system (GPS)/mapping features, gaming features, video streaming features, music playback features, and so forth, in addition to the basic telephone and text messaging capabilities. In order to enable these data-intensive applications, mobile devices, and by extension, the transceivers, the front end modules, and the antennas thereof, must be improved to greater levels of performance. In particular, these components must have increased bandwidth; current high-speed data transfer rates may require a bandwidth of 100 MHz or more depending upon specific applications and operating frequency bands.

With respect to antenna design, the aforementioned goals of high performance/increased bandwidth and reduced physical size tend to be mutually exclusive, and a final configuration is typically a carefully balanced compromise between these two considerations. For antennas utilized in mobile and other portable communication devices, several other factors must be considered as well. In addition to wide bandwidth, the antennas must meet high gain and efficiency requirements because of the limited power source inherent in those devices while also meeting the minimum communication link requirements for the entire system. Furthermore, there must be an adequately low return loss, so that satisfactory performance of the transceiver and the front end module are maintained even when the operating point has drifted beyond a normal range. As the various electrical components of mobile and portable communications devices are densely packed, interference between the antenna and such nearby components is also a source of performance degradation. With current antenna designs, the return loss (S11) at the edges of the operating frequency band is typically around −5 dB, leading to a reduced performance of the front end module. This, in turn, reduces the total radiated power and the total integrated sensitivity of the transceiver. Aside from performance considerations, modern communications devices must be manufactured and sold at a sufficiently low price point for market acceptance. Therefore, the reduction of costs associated with the materials and construction of antennas, as well as the other components, is an important design objective.

Accordingly, there is a need in the art for an improved, ultra wide-band antenna with excellent return loss characteristics across a typical operating bandwidth. There is also a need in the art for an antenna capable of stable performance under various environmental conditions such that the likelihood of de-tuning resulting from nearby components and other objects placed in close proximity to the antenna is reduced.

### BRIEF SUMMARY

The present disclosure generally contemplates an antenna assembly that is mountable to a printed circuit board with a radio frequency (RF) transceiver front end module mounted thereto. The antenna assembly may have an ultra-wide operating frequency bandwidth, that is, a greater than 100 MHz bandwidth depending on the frequency band, and has a return loss of −15 dB in the operating bandwidth. Additionally, the antenna assembly may have weak coupling with surrounding circuit components and other objects. Accordingly, a high degree of isolation can be achieved. Along these lines, high gain and high radiation efficiency is possible, and the overall dimensions of the antenna assembly may be kept small.

Several embodiments of the antenna assembly may have various features. One may be a radiating element that has a planar body defining a first confining slot. The dimensions of the first confining slot may correspond to a first set of resonance frequencies of the radiating element. Additionally, there may be a feeding line that extends from the radiating element in an angularly offset relationship to the planar body. The feeding line may be mountable to the printed circuit board and electrically connectible to the RF front end module. The antenna assembly may also include a first grounding line extending from the radiating element in an angularly offset relationship to the planar body. The first grounding line may also be mountable to the printed circuit board. Another feature of the antenna assembly may be a dielectric assembly that supports the planar body of the radiating element and is effective to reduce the dimensions of the radiating element. A first high frequency current loop may be formed from the feeding line to the radiating element about the first confining slot and to the first grounding line. This first high frequency current loop may confine current and electric fields on the radiating element. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a first embodiment of an antenna assembly mounted on a printed circuit board and electrically connected to an RF front end module;

FIG. 2 is a top plan view of a radiating element of the first embodiment of the antenna assembly, also illustrating a directional high frequency current loop;

FIG. 3 is a perspective view of a carrier of a dielectric assembly in accordance with one embodiment of the present disclosure;

FIG. 4 is a perspective view of a radome of the dielectric assembly in accordance with one embodiment that is cooperatively engageable to the carrier illustrated in FIG. 3;

FIG. 5 is a graph depicting the measured return loss of the first embodiment of the antenna assembly shown in FIG. 1;

FIGS. 6A-6C are graphs showing the measured radiation pattern of the first embodiment of the antenna assembly shown in FIG. 1;

FIG. 7 is a graph showing the measured peak antenna gain across the operating bandwidth of the first embodiment of the antenna assembly shown in FIG. 1;

FIG. 8 is a graph showing the measured radiation efficiency across the operating bandwidth of the first embodiment of the antenna assembly shown in FIG. 1;

FIG. 9 is a perspective view of a second embodiment of the antenna assembly;

FIG. 10 is a top plan view of a radiating element of the second embodiment of the antenna assembly, also illustrating first and second directional high frequency current loops;

FIG. 11 is a Smith chart showing the return loss of the second embodiment of the antenna assembly without a matching circuit;

FIG. 12 is a circuit diagram of an exemplary two-element matching circuit included in the second embodiment of the antenna assembly;

FIG. 13 is a graph showing the measured return loss of the second embodiment of the antenna assembly shown in FIG. 9;

FIG. 14A-C are graphs showing a simulated radiation pattern of the second embodiment of the antenna assembly shown in FIG. 9;

FIG. 15 is a graph showing the measured peak antenna gain of the second embodiment of the antenna assembly shown in FIG. 9;

FIG. 16 is a graph showing the measured radiation efficiency of the second embodiment of the antenna assembly shown in FIG. 9.

Common reference numerals are used throughout the drawings and the detailed description to indicate the same elements.

### DETAILED DESCRIPTION

Various embodiments of the present disclosure contemplate an antenna assembly having field-confined, ultra wide-band performance features. In particular, the antenna bandwidth is contemplated to be greater than 100 MHz for the Wireless Local Area Network (WLAN) frequency band of 2.4 GHz to 2.485 GHz. Across the typical operating bandwidth, the return loss is contemplated to be better than −15 dB. Additionally, the antenna assembly has stable performance and not prone to degradation or detuning resulting from nearby components and from objects placed in its vicinity. The detailed description set forth below in connection with the appended drawings is intended as a description of the several presently contemplated embodiments of the antenna assembly, and is not intended to represent the only form in which the disclosed invention may be developed or utilized. The description sets forth the functions and structural features in connection with the illustrated embodiments. It is to be understood, however, that the same or equivalent functions may be accomplished by different embodiments that are also intended to be encompassed within the scope of the present disclosure. It is further understood that the use of relational terms such as first and second, top and bottom, and the like are used solely to distinguish one from another entity without necessarily requiring or implying any actual such relationship or order between such entities.

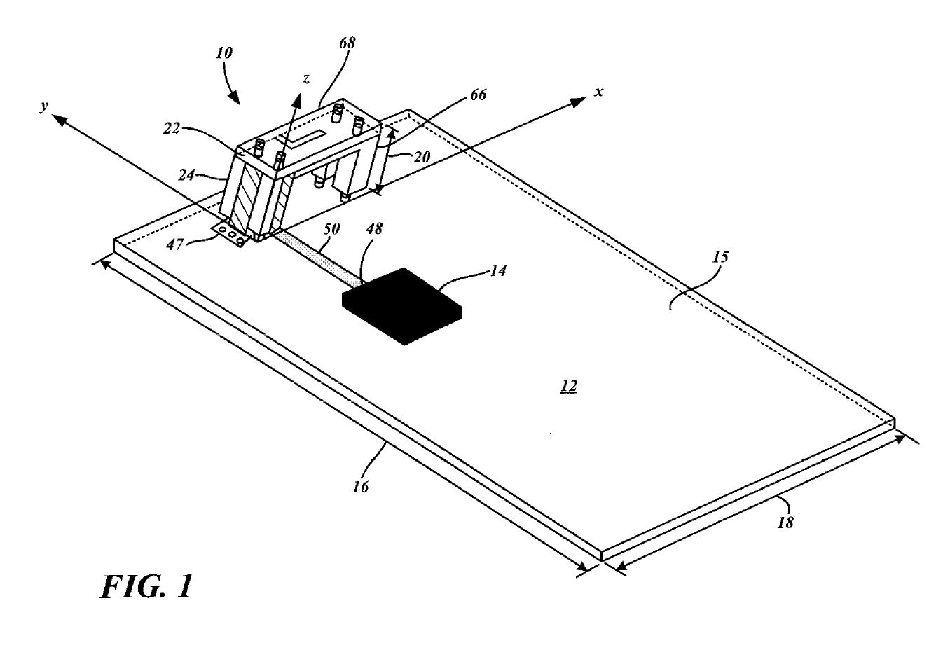

FIG. 1 shows a first embodiment of the antenna assembly 10 mounted to an exemplary printed circuit board 12. Also mounted to the printed circuit board 12 is a radio frequency (RF) front end module 14. It will be appreciated that, while not otherwise depicted, additional components necessary for wireless communications may also be mounted to the printed circuit board 12 and electrically interconnected, such as a transceiver, a central processing unit, and so forth. Along these lines, the printed circuit board 12 may be that of a communications device such as a smart phone, though the presently disclosed antenna assembly 10 need not be limited to such applications and the attendant frequency and bandwidth parameters. As will be discussed in further detail below, the operational parameters may be adjusted to meet the requirements of the intended application.

Since the antenna assembly 10 is mounted to the printed circuit board 12, the orientation in which the various features of the antenna assembly 10 are described, will be in relation to the printed circuit board 12. The printed circuit board 12 has a planar, quadrilateral configuration having a top surface 15, a length 16 and a width 18, as well as a lengthwise axis y, a widthwise axis x, and a vertical axis z. By way of example, the printed circuit board 12 may have dimensions of 80 mm×40 mm. With further particularity, the printed circuit board 12 may be a conventional glass-reinforced epoxy substrate of 60 mil thickness laminated with 1 oz. copper foil, also designated as FR4.Again, the specifics of the printed circuit board 12 are presented by way of example only, and it may take any shape that conforms to the structural constraints of the overall device. Extending vertically from the planar surface of the printed circuit board 12 along the axis z is the antenna assembly 10, and a height 20 is defined thereby.

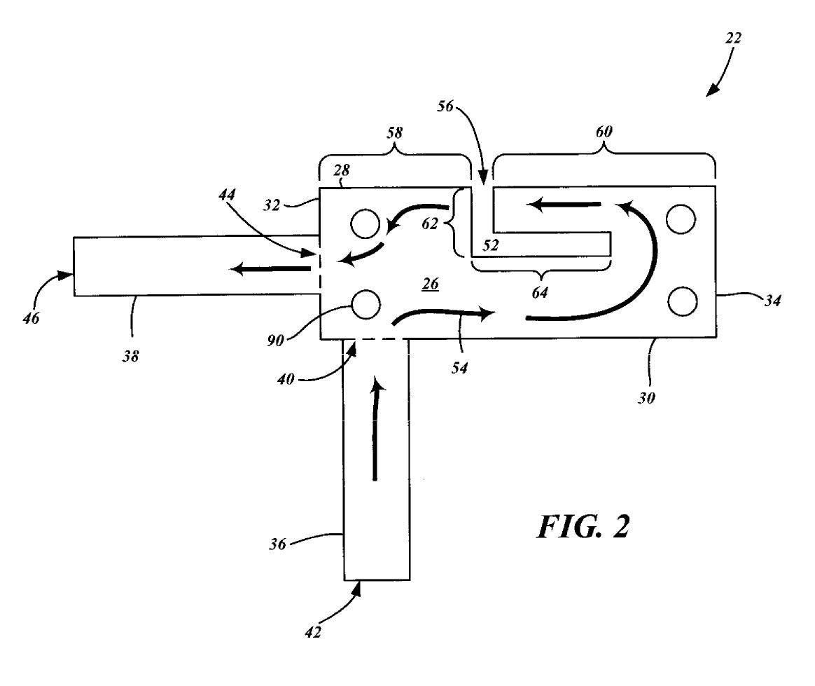

The first embodiment of the antenna assembly 10 shown in FIG. 1 includes a radiating element 22 supported by a dielectric assembly 24. In further detail best illustrated in FIG. 2, the radiating element 22 includes a planar body 26. The planar body 26 has a generally quadrilateral configuration defined by a longitudinal first edge 28, and an opposed longitudinal second edge 30. The planar body 26 is also defined by a lateral third edge 32 an opposed lateral fourth edge 34. The longitudinal first and second edges 28, 30 are perpendicular to the lateral third and fourth edges 32, 34. The first embodiment of the antenna assembly 10 is contemplated for use in a WLAN-compliant communication system and other Industrial-Scientific-Medical (ISM) Band systems, and is accordingly tuned for a center operating frequency of 2.45 GHz, with a 2.4 to 2.485 GHz band. As will be described in further detail below, the radiating element 22 and its subparts are specifically dimensioned for this operating parameter. In this regard, the length of the planar body 26, that is, the dimensions of the longitudinal first and second edges 28, 30 is 17 mm, while the width of the planar body 26, that is, the dimensions of the lateral third and fourth edges 32, 34, is 6.5 mm.

Extending from the planar body 26 is a feeding line 36 and a grounding line 38. Typical of conventional wireless communication devices, a single antenna is employed for both reception and transmission functions. Accordingly, the RF front end module 14 has a single antenna port 48 that is electrically connectible to the one feeding line 36 over a microstrip line 50. In one embodiment, the microstrip line 50 has an impedance of 50 Ohms for matching to the conventional input and output impedance of the RF front end module 14.

It is contemplated that the feeding line 36 and the grounding line 38 are in an angularly offset relationship to the planar body 26, but are structurally contiguous with the same. As best illustrated in FIG. 1, this angularly offset relationship is perpendicular or near perpendicular, and at least a portion of the vertical height 20 of the antenna assembly 10 is defined by the feeding line 36 and the grounding line 38. In further detail with reference again to FIG. 2, the feeding line 36 defines a proximal end 40 that is contiguous with the longitudinal second edge 30, and an opposed distal end 42 that may be soldered on to the printed circuit board 12. Similarly, the grounding line 38 defines a proximal end 44 that is contiguous with the lateral third edge 32, and an opposed distal end 46 that can be mechanically mounted and electrically connected to a grounding island 47 on the top layer of the printed circuit board 12.

The feeding line 36, grounding line 38, and the radiating element are understood to be constructed of a single sheet of conductive material such as copper, which in one contemplated embodiment, may have a thickness of 0.008 inches, or 0.203 mm. From the single sheet, material may be selectively removed to define such features. The feeding line 36 and the grounding line 38 are bent at the longitudinal second edge 30 and the lateral third edge 32, respectively, to be in the aforementioned angularly offset/perpendicular relationship to the planar body 26. In its unbent form shown in FIG. 2, the feeding line 36 extends from the longitudinal second edge 30, and the grounding line 38 extends from the lateral third edge 32. In this regard, the feeding line 36 can be characterized as being perpendicular to the grounding line 38. The feeding line 36 and the grounding line 38 have a length of approximately 10 mm, meaning that the planar body 26 of the radiating element 22 extends 10 mm above the mounting surface of the printed circuit board 12. Increasing the height of the radiating element 22 in this manner is understood to reduce its length, and increase operating frequency bandwidth. The feeding line 36 has a width of 2.8 mm while the grounding line has a width of 2.5 mm. The grounding line 38 can be positioned in the center between the longitudinal first edge 28 and the longitudinal second edge 30, though this is by way of example only and not of limitation. The feeding line 36, however, is positioned toward the end closer to the lateral third edge 32 for reasons that will be discussed more fully below. Although the foregoing configuration contemplates the radiating element 22, the feeding line 36, and the grounding line 38 being integral, it is also contemplated that such components are separately constructed and subsequently attached.

It will be recognized by those having ordinary skill in the art that for a given conductor, the electric field line is perpendicular to its surface, while the magnetic field is tangential to its surface and forms a circular closed loop. Accordingly, a magnetic field antenna is understood to have less coupling with surrounding circuit components, and be resistant to detuning. In accordance with various embodiments of the present disclosure, the planar body 26 defines a first confining slot 52. With the antenna being fed by an external source, a high frequency loop 54 is formed from the feeding line 36 to the radiating element 22, about the first confining slot 52 and to the grounding line 38. The feeding line 36 is thus the origin of the high frequency loop 54, while the grounding line 38 is its terminus. The impedance of the high frequency loop 54, and hence the return loss, is dependent upon the dimensions between the feeding line 36 and the grounding line 38. Furthermore, the length of the high frequency loop 54, and by definition, the dimensions of the first confining slot 52, correspond to a first set of resonant frequencies of the radiating element 22.

The high frequency loop 54 is understood to confine the current and electric fields on the radiating element 22 or the antenna volume to result in the aforementioned magnetic field antenna. In operation, coupling between the antenna assembly 10 and the surrounding circuit components can be reduced. Moreover, coupling with other objects that come into close proximity to the antenna assembly 10 during use, such as a human hand or head, can also be reduced. The first confining slot 52 is also understood to reduce the dimensions of the antenna assembly 10 while still achieving the aforementioned performance objectives of wide bandwidth, acceptable return loss, high gain, and high radiation efficiency.

Having discussed the general functional features of the radiating element 22, additional structural details will now be considered. As shown in FIG. 2 and mentioned briefly above, the planar body 26 defines the first confining slot 52. The longitudinal first edge 28 defines an open end 56 of the first confining slot 52. According to one embodiment, the opening is 1 mm wide, and with an overall length of 17 mm, the longitudinal first edge 28 is divided into a first segment 58 of 6.5 mm and a second segment 60 of 9.5 mm. The open end 56 of the first confining slot 52 is defined by the longitudinal first edge 28 and opposite the feeding line 36 to reduce coupling with components proximal thereto. The first confining slot 52 is also characterized by a first section 62 that extends laterally from the open end 56, along the same axial direction as the lateral third and fourth edges 32, 34 of the planar body 26. Along these lines, the first section 62 is understood to be perpendicular to the longitudinal first edge 28. The first confining slot 52 is further characterized by a second section 64 that extends longitudinally from the first section 62, along the same axial direction as the longitudinal first and second edges 28, 30 of the planar body 26. The second section 64 is understood to be contiguous with the first section 62, and so the first confining slot 52 has an L-shaped configuration in which the first section 62 is perpendicular to the second section 64. In accordance with one embodiment of the present disclosure, the longer edge of the first section 62 has a length of 3 mm while the opposite shorter edge of the first section 62 has a length of 2 mm, and the second section 64 has a length of 6 mm. Considering that open end 56 has a width of 1 mm, the width of the first section 62, as well as the width of the second section 64, is likewise contemplated to be 1 mm.

As indicated above, the dielectric assembly 24 supports the radiating element 22, and is itself mounted to the printed circuit board 12. It is understood that the dielectric assembly 24 facilitates size reductions with respect to the radiating element 22. It will be recognized by those having ordinary skill in the art that the free space wavelength (λ₀) of an electromagnetic wave in a dielectric material is reduced by εᵣ^{1/2} where εᵣ is the dielectric constant. Thus, it is possible to reduce the dimensions of the radiating element 22 with the introduction of the dielectric material. Referring to FIG. 1, the dielectric assembly 24 includes a carrier 66 and a radome 68, and the radiating element 22 is sandwiched therebetween, that is, the radiating element 22 is interposed between the carrier 66 and the radome 68. In one embodiment, the carrier 66 and the radome 68 are constructed of plastic. The dielectric assembly 24 is known to reduce the peak gain of the antenna assembly 10 by about 0.2 dB, but this is considered an acceptable loss for most applications.

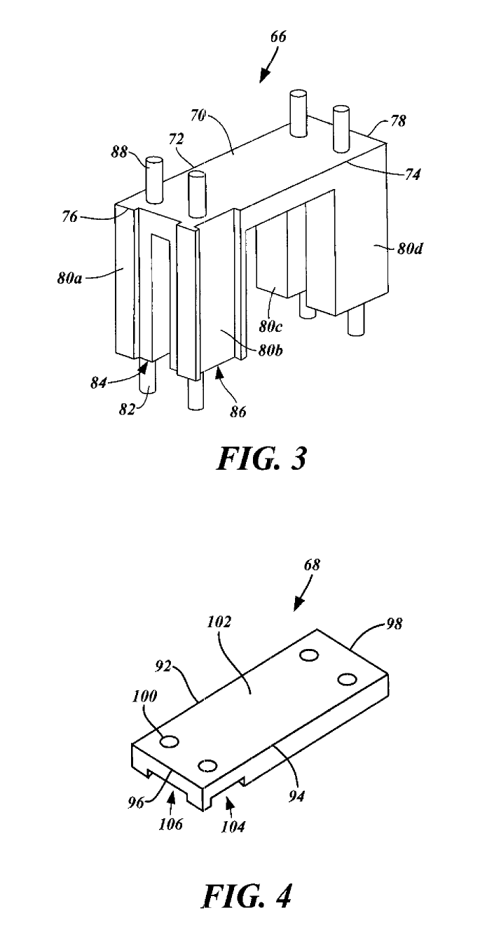

Additional details of the dielectric assembly 24 will now be discussed with reference to FIGS. 3 and 4. FIG. 3 illustrates an embodiment of the carrier 66 that can be utilized with the radiating element 22 shown in FIG. 2. Specifically, the carrier 66 includes a platform 70 that has similar or identical dimensions of the planar body 26 of the radiating element 22. As described in relation to the planar body 26, the platform 70 also has a longitudinal first edge 72 and an opposed longitudinal second edge 74. The platform 70 also has a lateral third edge 76 and an opposed lateral fourth edge 78. The carrier 66 includes a first leg 80a that is generally disposed in the corner between the longitudinal first edge 72 and the lateral third edge 76. There is also a second leg 80b generally disposed in the corner between the longitudinal second edge 74 and the lateral third edge 76. Furthermore, there is a third leg 80c generally disposed in the corner between the longitudinal first edge 72 and the lateral fourth edge 78, as well as a fourth leg 80d that is generally disposed in the corner between the longitudinal second edge 74 and the lateral fourth edge 78. The first leg 80a, the second leg 80b, the third leg 80c, and the fourth leg 80d will collectively be referred to as the legs 80.

Each of the legs 80 is understood to extend vertically from under the platform 70, and have the same length. As indicated above, the height of the feeding line 36 and the grounding line 38 is contemplated to be 10 mm, and accordingly, the length of the legs 80 is likewise understood to be 10 mm. In order for each of the legs 80 to be secured to the printed circuit board 12, there are via pins 82 extending from the bottom thereof. It is understood that the printed circuit board 12 include via holes through which the pins 82 are inserted.

A portion of the first leg 80a and the second leg 80b that defines the lateral third edge 76 also defines a channel 84 having a depth that corresponds to the thickness of the copper plate (or other metallic material) for the grounding line 38, as well as a width that corresponds to the width of the same. The channel 84 extends along the entire vertical length of the first and second legs 80a, 80b, and is understood to receive the grounding line 38 such that it is flush or substantially flush with the vertical surface of the lateral third edge 76. As indicated above, the width of the grounding line 38 is 2.5 mm, hence the channel 84 is understood to be about 2.5 mm. Along these lines, a portion of the second leg 80b that partially defines the longitudinal second edge 74 defines a channel 86 that receives the feeding line 36. The channel 86 extends along the entire vertical length of the second leg 80b, and has a depth and width corresponding to the thickness and width of the feeding line 36. Similar to the grounding line 38, the feeding line 36 is understood to be flush or substantially flush with the vertical surface of the longitudinal second edge 74.

Referring to FIGS. 2 and 3, the platform 70 includes mounting pins 88 extending therefrom, and are positioned thereon to correspond to a set of complementary alignment/mounting holes 90 defined by the planar body 26 of the radiating element 22. The mounting pins 88 are to be inserted through the mounting holes 90, thereby securing the radiating element 22 to the carrier 66 and preventing lateral movement of the same. The radius of the inner diameter of the alignment/mounting holes 90 is understood to be 0.6 mm, and the radius of the outer diameter of the mounting pins 88 is understood to be slightly less than 0.6 mm for ready insertion and frictional retention. While specific dimensions have been provided, it will be appreciated that any other dimensions may be substituted.

FIG. 4 illustrates the radome 68 of the dielectric assembly 24. With the radiating element 22 secured to the platform 70 of the carrier 66, the radome 68 is attached. The radome 68 is understood to have similar dimensions as the platform 70, and likewise defines a longitudinal first edge 92, an opposed longitudinal second edge 94, a lateral third edge 96, and an opposed lateral fourth edge 98. The radome 68 further includes alignment holes 100 that are coaxial with, and have the same dimensions as, the mounting holes 90 on the planar body 26 of the radiating element 22. The mounting pins 88 extending from the platform 70 are inserted through the mounting holes 100 and frictionally retained thereby. In further detail, it is contemplated that the mounting pins 88 have a height that generally corresponds to the thickness of the planar body 26 and the radome 68, such that it is flush with a top surface 102 of the radome 68. It is also contemplated that the mounting pins 88 have a height slightly shorter than the thickness of the planar body 26 and the radome 68. The vertical surface of the longitudinal second edge 94 includes a channel 104 having a width and thickness corresponding to the width and thickness of the feeding line 36, and the vertical surface of the lateral third edge 96 includes a channel 106 having a width and thickness corresponding to the width and thickness of the grounding line 38. The respective channels 104, 106 are understood to provide an opening through which the feeding line 36 and the ground line 38 are routed from the inner portion of the dielectric assembly 24 to the outer portion along the vertical surface of the carrier 66.

It was previously noted that the dielectric assembly 24, including the carrier 66 and the radome 68, are constructed of plastic. According to one embodiment of the present disclosure, the carrier 66 and the radome 68 have different dielectric properties. Specifically, the carrier is constructed of acrylonitrile butadiene styrene (ABS) plastic, while the radome is constructed of polyvinyl chloride (PVC) plastic.

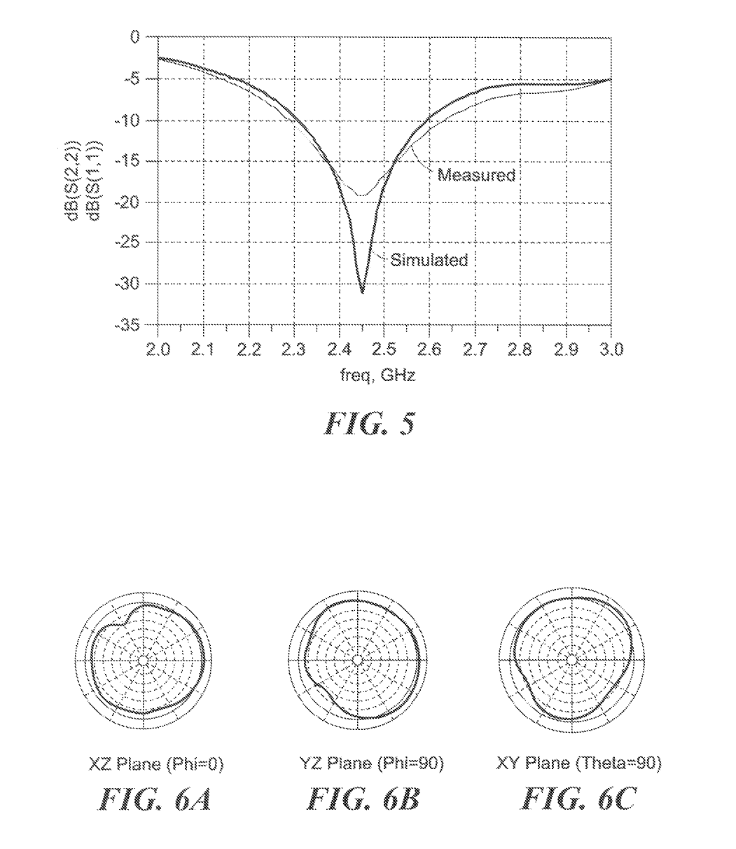

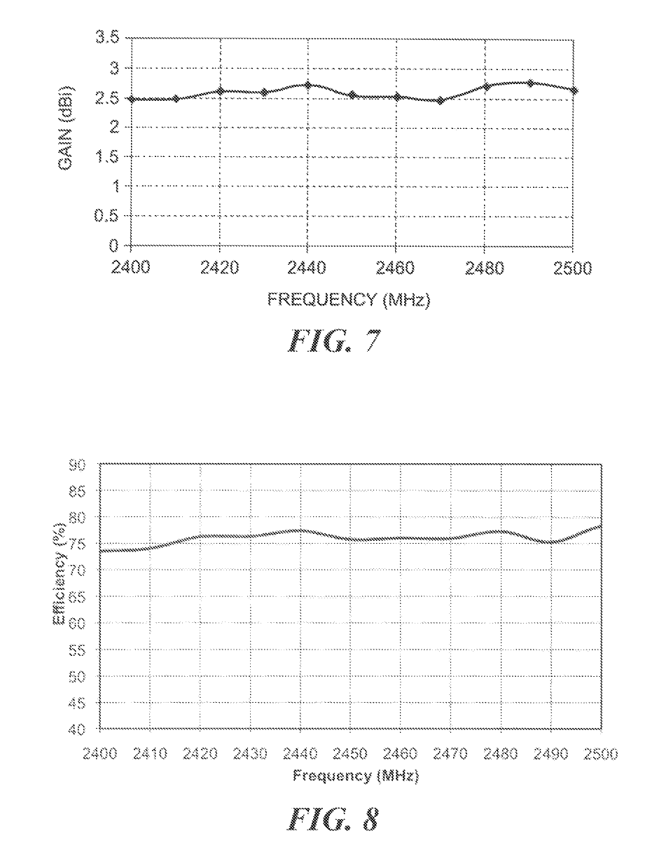

The above-described first embodiment of the antenna assembly 10 is envisioned to have comparatively small dimensions, wide bandwidth, adequate return loss, and reduced coupling with nearby objects. The performance of the antenna assembly 10 has been simulated and tested for WLAN operation in a 2.45 GHz operating frequency and an ISM operating frequency band of 2.4 to 2.485 GHz. For purposes of this analysis, losses from the RF cable, the connector, and the microstrip lines were de-embedded. The graph of FIG. 5 illustrates the measured and simulated return loss in these operating ranges. As shown, the measured return loss is below −17 dB in the operating frequency band. Additionally, the graph of FIG. 6A illustrates the measured radiation pattern in the XZ plane, the graph of FIG. 6B illustrates the measured radiation pattern in the YZ plane, and the graph of FIG. 6C illustrates the measured radiation pattern in the XY plane, together which show the radiation pattern of the antenna assembly 10 being nearly omnidirectional. As shown in the graph of FIG. 7, the measured peak gain across the operating frequency band is above 2.5 dBi, or decibel isotropic, which refers to the forward gain of an antenna compared to a hypothetical isotropic antenna. The graph of FIG. 8 illustrates the measured efficiency of the antenna assembly 10, which is above 73% across the operating frequency band. It is expressly contemplated that the first embodiment of the antenna assembly 10 is adaptable to other frequency bands and other applications besides those noted above.

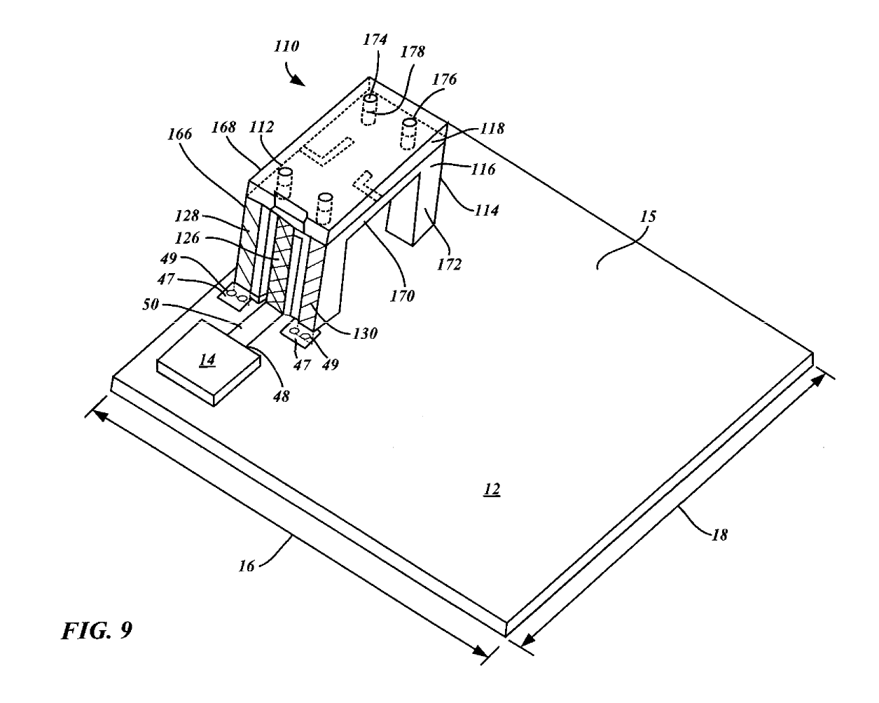

Referring now to FIG. 9, a second embodiment of the antenna assembly 110 is mounted to the printed circuit board 12. Again, also mounted to the printed circuit board 12 is the RF front end module 14 with the antenna port 48. Additional circuit components may be included on the printed circuit board 12 that facilitates wireless communications, but such components are not shown for the sake of brevity. The printed circuit board 12 is understood to have the identical configuration described above, i.e., FR4 substrate with 60 mil thickness, 1 oz copper, dimensions of 80 mm×40 mm, and defined by a top surface 15, a length 16, and a width 18.

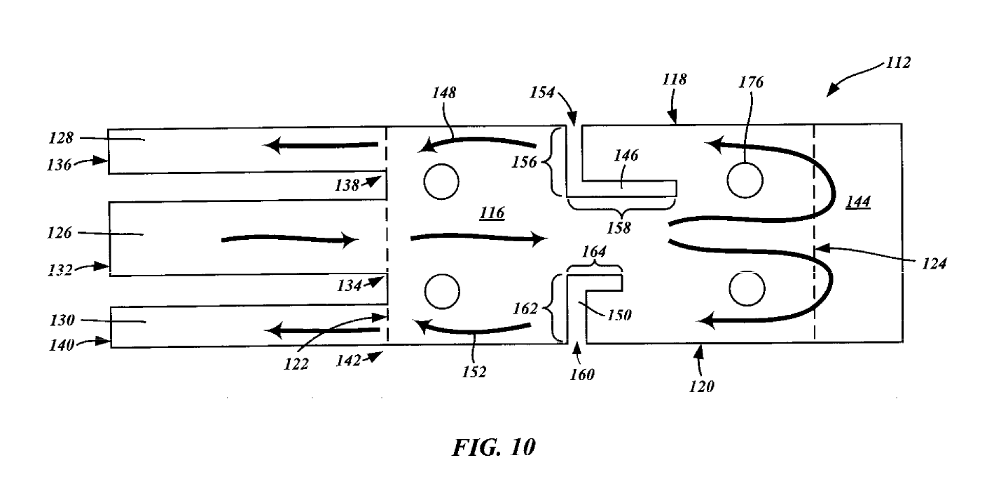

The second embodiment of the antenna assembly 110 includes a radiating element 112 supported by a dielectric assembly 114. Further details of the radiating element 112 are shown in FIG. 10, and is understood to have several notable differences in comparison to the first embodiment of the antenna assembly 10 discussed above. The radiating element 112 includes a planar body 116 having a generally quadrilateral configuration defined by a longitudinal first edge 118, an opposed longitudinal second edge 120, a lateral third edge 122, and an opposed lateral fourth edge 124. The longitudinal first edge 118 and the longitudinal second edge 120 are perpendicular to the lateral third edge 122 and the lateral fourth edge 124.

The second embodiment of the antenna assembly 110, particularly configured with the structural features described in greater detail below, is contemplated for use in a WLAN communication system with an operating frequency of 2.45 GHz and an ISM frequency band of 2.4 to 2.485 GHz. However, it will be appreciated that the specific configuration may be modified to accommodate other operating frequencies and operating frequency bands. In accordance with the second embodiment of the antenna assembly 110, the longitudinal first edge 118 and the longitudinal second edge 120 have a dimension of 15.5 mm, while the lateral third edge 122 and the lateral fourth edge 124 have a dimension of 8 mm. The radiating element 112 is contemplated to have a thickness 0.008 inches or 0.203 mm, and constructed of copper, though any other material may be substituted.

Extending from the radiating element 112 is a feeding line 126, a first grounding line 128, and a second grounding line 130. With the radiating element 112 mounted to the dielectric assembly 114 as shown in FIG. 9, the feeding line 126, the first grounding line 128, and the second grounding line 130 are at an angularly offset relationship to the planar body 116 as well as to the printed circuit board 12 when appropriately mounted thereto. In particular, this angularly offset relationship is perpendicular, and partially defines the vertical height of the antenna assembly 110. As shown in FIG. 10, the feeding line 126, the first grounding line 128, and the second grounding line 130 extend from the lateral third edge 122 in a spaced, parallel relationship to each other along the longitudinal axis of the longitudinal first edge 118 and the longitudinal second edge 120. However, the feeding line 126, the first grounding line 128, and the second grounding line are bent at the lateral third edge 122 in its completed form. The feeding line 126 is characterized by a distal end 132 that is soldered on to the printed circuit board 12. An opposed proximal end 134 is contiguous with the bend or the lateral third edge 122 of the planar body 116. In addition, the first grounding line 128 defines a distal end 136 that may is soldered on to a grounding island 47 on the printed circuit board 12 which may have via holes 49 connected to the bottom or lower layer of the same. The first grounding line 128 also defines an opposed proximal end 138 that is contiguous with the lateral third edge 122 of the planar body 116. The second grounding line 130 likewise defines a distal end 140 and an opposed proximal end 142, with the distal end 140 being soldered on to the aforementioned grounding lines with via holes.

As previously indicated, the feeding line 126, the first grounding line 128, and the second grounding line 130 are in a spaced relationship. In this regard, one embodiment envisions the spacing to be approximately 1 mm. The first and second grounding lines 128, 130 are understood to be narrower in width at approximately 1.6 mm, while the feeding line 126 is understood be wider in width at approximately 2.8 mm. In accordance with various embodiments, the vertical height of the radiating element 112 is contemplated to be 10 mm; accordingly, the length of the feeding line 126, the first grounding line 128, and the second grounding line 130 is also 10 mm.

Opposite the feeding line 126 and the first and second grounding lines 128, 130, there is a bent section 144, which is bent along the lateral fourth edge 124. The bent section 144 is contemplated to be perpendicular to the planar body 116, and, by way of example only, may be 3.2 mm. Accordingly, the length of the radiating element 112 can be reduced.

Similar to the first embodiment of the antenna assembly 10, the second embodiment of the antenna assembly 110 includes a first confining slot 146 that is understood to reduce coupling between the radiating element 112 and nearby components or objects. With the antenna fed by an external source, a first high frequency loop 148 is formed from the feeding line 126 to the radiating element 112, about the first confining slot 146, to the first grounding line 128. The feeding line 126 is understood to be the origin of the first high frequency loop 148, and the first grounding line 128 is understood to be its terminus. The impedance of the first high frequency loop 148 and the return loss is dependent upon the dimensions between the feeding line 126 and the first grounding line 128. The length of the first high frequency loop 148 and thus the dimensions of the first confining slot 146 correspond to a first set of resonant frequencies of the radiating element 112.

In addition to the first confining slot 146, the second embodiment of the antenna assembly 110 includes a second confining slot 150. A second high frequency loop 152 is formed from the feeding line 126 to the radiating element 112, about the second confining slot 150, to the second grounding line 130. In this regard, the feeding line 126 is also the origin of the second high frequency loop 152. The terminus of the second high frequency loop 152 is the second grounding line 130. The second high frequency loop 152 is understood to confine the current and electric fields for resisting de-tuning and improving performance stability. The impedance of the second high frequency loop 152 and the return loss is similarly dependent on the dimensions between the feeding line 126 and the second grounding line 130. Additionally, the length of the second high frequency loop 152 and the dimensions of the second confining slot 150 correspond to a second set of resonant frequencies of the radiating element 112.

The length of the first high frequency loop 148 is configured differently from the length of the second high frequency loop 152, hence there are different resonant frequencies. Different lengths with respect to the first high frequency loop 148 and the second high frequency loop 152 are achieved by varying the dimensions of the first confining slot 146 and the second confining slot 150, as will be described in greater detail below. In accordance with various embodiments of the present disclosure, superposition of multiple resonant frequencies is contemplated to form a radiating element with different resonant peaks in a given frequency range and define an aggregate operating frequency bandwidth. With these features, an antenna with ultra-wide bandwidth is envisioned.

As best illustrated in FIG. 10, the planar body 116 defines the first confining slot 146 and the second confining slot 150. The longitudinal first edge 118 defines a first open end 154 of the first confining slot 146. According to one embodiment, the first open end 154 is 0.6 mm wide and is defined by the longitudinal first edge 118. The first confining slot 146 is also characterized by a first section 156 that extends laterally from the first open end 154, along the same axial direction as the lateral third and fourth edges 122, 124 of the planar body 116. The first section 156 is understood to be perpendicular to the longitudinal first edge 118, and is contemplated to be approximately 2.6 mm in length. The first confining slot 146 is further characterized by a second section 158 that extends longitudinally from the first section 156, along the same axial direction as the longitudinal first and second edges 118, 120 of the planar body 116. The length of the second section 158 is contemplated to be approximately 4 mm, and is contiguous with the first section 156. Accordingly, the first confining slot 146 has an L-shaped configuration in which the first section 156 is perpendicular to the second section 158. As the first open end 154 has a width of 0.6 mm, the width of the first section 156, as well as the width of the second section 158, is likewise contemplated to be 0.6 mm.

Similarly, the longitudinal second edge 120 defines a second open end 160 of the second confining slot 150. Like the first confining slot 146, the second confining slot 150 is defined by a first section 162 extending laterally from the second open end 160, along the same axial direction as the lateral third and fourth edges 122, 124 of the planar body 116. The dimensions of the first section 162 of the second confining slot 150 is understood to be the same as the dimensions of the first section 156 of the first confining slot 146, i.e., 2.6 mm. Additionally, the second confining slot 150 is defined by a second section 164 that extends longitudinally from the first section 162 and is contiguous therewith, along the same axial direction as the longitudinal first and second edges 118, 120 of the planar body 116. The dimensions of the second section 164 of the second confining slot 150 is understood to be different from the dimensions of the second section 158 of the first confining slot 146, being 2 mm. The second confining slot 150 is also contemplated to have an L-shaped configuration. The length of the first section 156 of the first confining slot 146 may differ from the first section 162 if the lengths of the respective second sections 158, 164 are modified such that the relationship between the total length of the first confining slot 146 and the second confining slot 159 is maintained.

With reference to FIG. 9, as briefly mentioned above, the dielectric assembly 114 supports the radiating element 112 and is mounted to the printed circuit board 12. The dielectric assembly 114 is understood to facilitate size reductions of the radiating element 112 because the free space wavelength of an electromagnetic wave in a dielectric material is reduced by a factor related to the dielectric constant. In further detail, the dielectric assembly 114 includes a carrier 166 and a radome 168. It is recognized that these components reduce the peak gain by about 0.2 dB, but such losses are typically deemed to be acceptable.

The various features noted above in relation to the first embodiment of the dielectric assembly 24 including the carrier 66 and the radome 68 thereof are understood to be the same in the second embodiment of the dielectric assembly 114. For instance, the corresponding carrier 166 includes a platform 170 of similar or identical dimensions as the planar body 116 of the radiating element 112. Extending from the corners of the platform 170 are legs 172 that define a vertical height and elevate the platform 170 from the surface of the printed circuit board 12. The legs 172 are understood to include a modality for securing the same to the printed circuit board 12. Mounted to the platform 170 is the planar body 116 of the radiating element 112. Specifically, the platform 170 includes a set of mounting pins 174 that are received in series of mounting holes 176 defined by the planar body 116. The radome 168 is attached on to the planar body 116 and the carrier 166. In this regard, the radome 168 defines a series of coaxial mounting holes 178 that receives and frictionally retains the mounting pins 174.

Typically, antennas are designed to be match to a 50 Ohm characteristic impedance, as RF circuits, and front end modules in particular, have input and output impedances of 50 Ohm for the sake of impedance matching. It is recognized, however, that the free space that bounds the antenna has an impedance of 377 Ohm. This impedance is treated as a load during transmission, or a source during reception. Conventional antenna designs apply a radiation boundary condition that matches the 377 Ohm free space impedance to the 50 Ohm impedance of the connected RF circuit. As such, the antenna serves as a basic impedance matching network. When the impedance is directly matched from 377 Ohm to 50 Ohm, it is understood that the operating frequency bandwidth may be narrow depending on the antenna structure and the operating frequency band. On the other hand, if the impedance is matched in multiple steps, the operating frequency bandwidth could be increased. Thus, in accordance with one embodiment of the present disclosure, a primary impedance of the antenna assembly 110 is matched to an impedance of the RF front end module 14 in a plurality of steps.

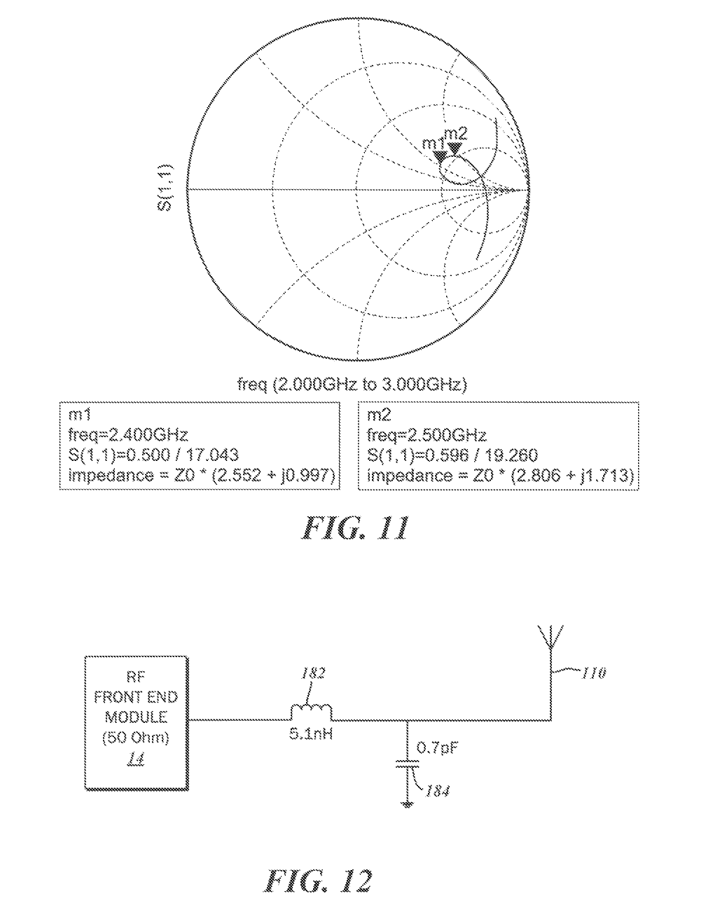

The second embodiment of the antenna assembly 110 described above is understood to have an impedance of more than 50 Ohm, but less than 377 Ohm. By way of example, this impedance may be 200 Ohm. As shown in the Smith chart of FIG. 11 that show the characteristics of the antenna assembly 110, a small loop or cusp can be observed, which indicates that a flat frequency response across the operating frequency bandwidth is achieved. Additionally, the relatively small size of the cusp indicates that the input return loss (S11) of the frequency response is flat.

FIG. 12 illustrates an exemplary two-element matching circuit 180 that interconnects the RF front end module 14 and the antenna assembly 110. The matching circuit 180 has a secondary impedance that is intermediate the primary impedance of the antenna assembly and the terminal impedance of the RF front end module 14. The aforementioned microstrip line 50 is understood to be a part of the matching circuit 180. In further detail, the matching circuit 180 includes a first inductor 182 connected to the RF front end module 14, and has an inductance value of 5.1 nH. Additionally, the first inductor 182 is connected to the antenna assembly 110 and the first capacitor 184 tied to ground having a capacitance value of 0.7 pF. While a specific configuration of the two-element matching circuit 180 is presented, it will be appreciated that any other suitable impedance matching circuit may be utilized.

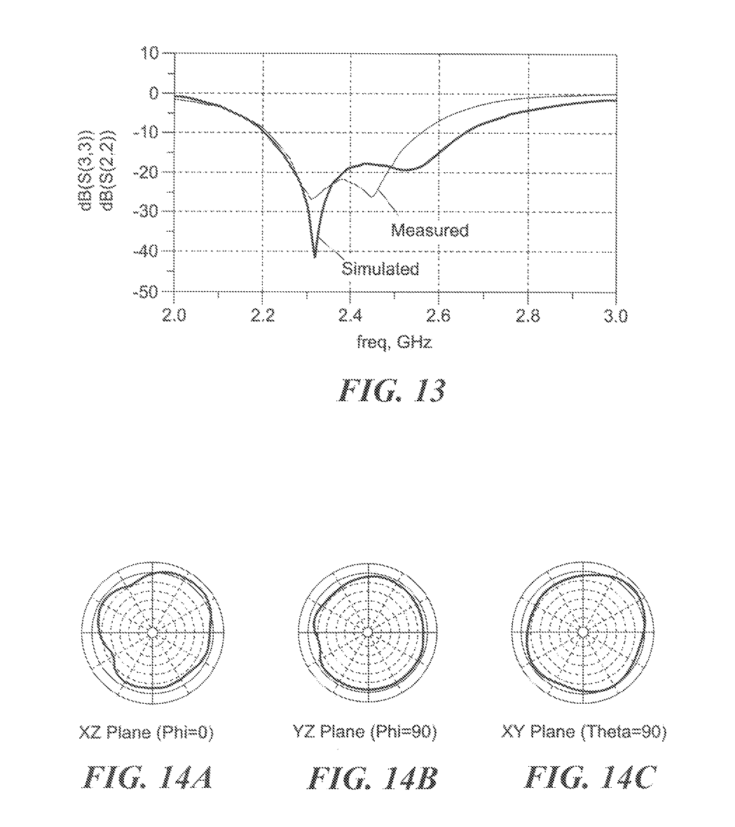

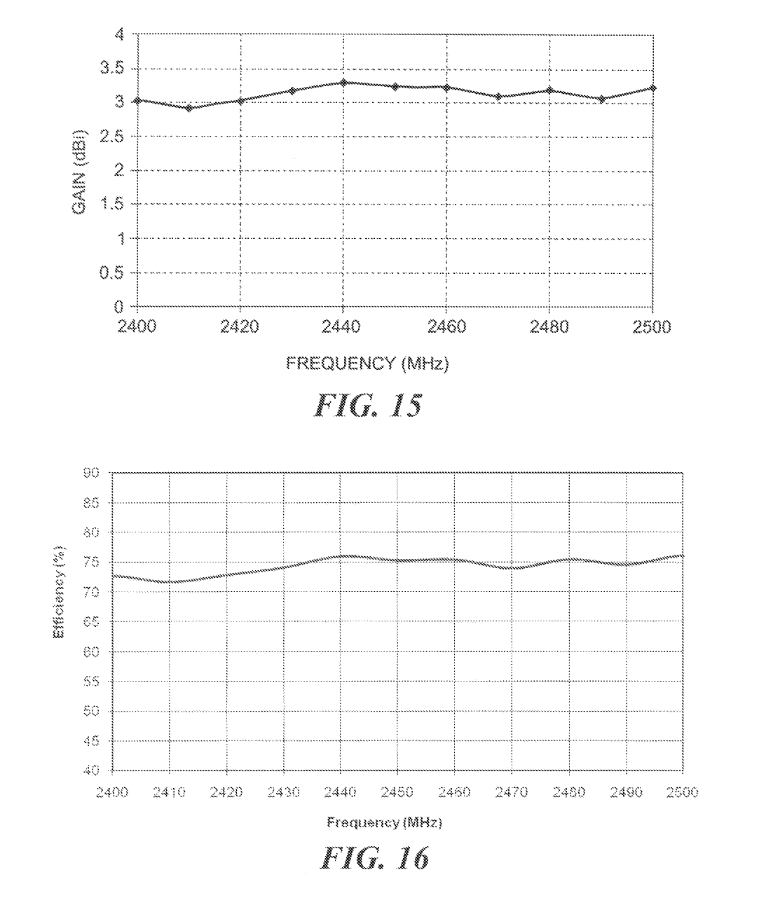

The above-described second embodiment of the antenna assembly 110 is envisioned to have comparatively small dimensions, wide bandwidth, excellent return loss, and reduced coupling with nearby objects. The performance of the antenna assembly 110 has been simulated and tested for WLAN operation in a 2.45 GHz operating frequency and an ISM operating frequency band of 2.4 to 2.485 GHz. For purposes of this analysis, losses from the RF cable, the connector, and the microstrip lines were de-embedded. The graph of FIG. 13 illustrates the measured and simulated return loss in these operating frequency ranges, which is observed to be better than −22 dB across the operating frequency band. Additionally, the graph of FIG. 14A illustrates the measured radiation pattern in the XZ plane, the graph of FIG. 14B illustrates the measured radiation pattern in the YZ plane, and the graph of FIG. 14C illustrates the measured radiation pattern in the XY plane, together which show a radiation pattern of the antenna assembly 110 being nearly omnidirectional. As shown in the graph of FIG. 15, the measured peak gain across the operating frequency band is above 3 dBi. The graph of FIG. 16 illustrates the measured antenna efficiency of the antenna assembly 110, which is above 72% across the operating frequency band. It is expressly contemplated that the second embodiment of the antenna assembly 110 is adaptable to other frequency bands and other applications besides those noted above.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary for the fundamental understanding of the antenna assembly, the description taken with the drawings making apparent to those skilled in the art how the several forms of the present invention may be embodied in practice.

What is claimed is:

1. An antenna assembly mountable to a printed circuit board with a radio frequency (RF) front end module mounted thereto, the antenna assembly comprising:
a radiating element with a planar body defining a first confining slot, the dimensions of the first confining slot corresponding to a first set of resonance frequencies of the radiating element;
a feeding line extending from the radiating element in an angularly offset relationship to the planar body, the feeding line being mountable to the printed circuit board and electrically connectible to the RF front end module;
a first grounding line extending from the radiating element in an angularly offset relationship to the planar body, the first grounding line being mountable to the printed circuit board; and
a dielectric assembly supporting the planar body of the radiating element;
wherein a first high frequency current loop is formed from the feeding line to the radiating element about the first confining slot and to the first grounding line, the first high frequency current loop confining current and electric fields on the radiating element.

2. The antenna assembly of claim 1, wherein the planar body has a generally quadrilateral configuration defined by opposed longitudinal first and second edges and opposed lateral third and fourth edges.

3. The antenna assembly of claim 2, wherein the longitudinal first edge defines a first open end of the first confining slot, a first section of the first confining slot extending laterally from the first open end and a second section of the first confining slot extending longitudinally, the first section of the first confining slot being contiguous with the second section of the first confining slot.

4. The antenna assembly of claim 3, wherein the first section of the first confining slot is perpendicular to the second section of the first confining slot.

5. The antenna assembly of claim 3, wherein the feeding line extends from the longitudinal second edge opposite the first open end of the first confining slot, the feeding line defining an origin of the first high frequency current loop.

6. The antenna assembly of claim 2, wherein the first grounding line extends from the lateral third edge, the first grounding line defining a terminus of the first high frequency current loop.

7. The antenna assembly of claim 1, wherein the angularly offset relationship between the planar body of the radiating element and the respective one of the feeding line and the first grounding line is perpendicular.

8. The antenna assembly of claim 1, further comprising a second grounding line extending from the radiating element in an angularly offset relationship to the planar body, the second grounding line being mountable to the printed circuit board.

9. The antenna assembly of claim 8, wherein:
the planar body of the radiating element defines a second confining slot, the dimensions of the second confining slot corresponding to a second set of resonance frequencies of the radiating element;
a second high frequency loop is formed from the feeding line to the radiating element about the second confining slot and to the second grounding line, the second high frequency current loop confining current and electric fields on the radiating element; and
the first set of resonance frequencies and the second set of resonance frequencies define an aggregated operating bandwidth of the antenna assembly.

10. The antenna assembly of claim 9, wherein the planar body has a generally quadrilateral configuration defined by opposed longitudinal first and second edges and opposed lateral third and fourth edges.

11. The antenna assembly of claim 10, wherein:
the longitudinal first edge defines a first open end of the first confining slot, a first section of the first confining slot extending laterally from the first open end and a second section of the first confining slot extending longitudinally, the first section of the first confining slot being contiguous with the second section of the first confining slot;
the longitudinal second edge defines a second open end of the second confining slot, a first section of the second confining slot extending laterally from the second open end and a second section of the second confining slot extending longitudinally, the first section of the second confining slot being contiguous with the second section of the second confining slot.

12. The antenna assembly of claim 11, wherein:
the feeding line, the first grounding line, and the second grounding line extend from the lateral third edge in a spaced, parallel relationship, the feeding line defining an origin of the first and second high frequency current loops;
the first grounding line defines a terminus of the first high frequency current loop; and
the second grounding line defines a terminus of the second high frequency current loop.

13. The antenna assembly of claim 11, wherein the dimensions of the first section of the first confining slot are substantially identical to the first section of the second confining slot.

14. The antenna assembly of claim 11, wherein the dimensions of the first section of the first confining slot are different from the first section of the second confining slot.

15. The antenna assembly of claim 11, wherein the dimensions of the second section of the first confining slot are different from the second section of the second confining slot.

16. The antenna assembly of claim 11, wherein the feeding line is disposed between the first grounding line and the second grounding line.

17. The antenna assembly of claim 1, wherein the first grounding line and the feeding line are structurally contiguous with the radiating element.

18. The antenna assembly of claim 1, wherein a primary impedance of the antenna assembly is matched to an impedance of the RF front end module in a plurality of steps.

19. The antenna assembly of claim 18, further comprising a matching circuit having a secondary impedance, the antenna assembly being connectible to the RF front end module over the matching circuit and a microstrip line.

20. The antenna assembly of claim 19, wherein the secondary impedance of the matching circuit is 50 Ohms, matched to the RF front end module.

21. The antenna assembly of claim 19, wherein the primary impedance of the antenna assembly is different from the secondary impedance of the matching circuit.

22. The antenna assembly of claim 1, wherein the dielectric assembly is constructed of plastic.

23. The antenna assembly of claim 1, wherein the dielectric assembly includes:
a carrier including a platform and at least one leg projecting therefrom, the planar body of the radiating element being mounted to the platform and the at least one leg mountable to the printed circuit board; and
a radome mounted to the carrier and the radiating element, the planar body of the radiating element being interposed between the platform of the carrier and the radome.

24. The antenna assembly of claim 23, wherein the at least one leg defines a channel receptive to a one of the first feeding line and the first grounding line.

25. The antenna assembly of claim 23, wherein:
the planar body of the radiating element defines a plurality of alignment holes;
the radome defines a plurality of alignment holes coaxial with the alignment holes defined by the radiating element; and
the carrier including a plurality of mounting pins coupled to the radiating element and the radome via the respective alignment holes thereof.

26. The antenna assembly of claim 23, wherein the carrier and the radome have different dielectric properties.

27. The antenna assembly of claim 26, wherein:
the carrier is constructed of acrylonitrile butadiene styrene (ABS) plastic; and
the radome is constructed of polyvinyl chloride (PVC) plastic.
